(19) United States
(12) Patent Application Publication
(10) Pub. No.: US 2009/0327896 A1
(43) Pub. Date: Dec. 31, 2009

(54) DYNAMIC MEDIA AUGMENTATION FOR PRESENTATIONS

(75) Inventors: Gurdeep Singh Pall, Medina, WA (US); Ajitesh Kishore, Kirkland, WA (US); Lewis C. Levin, Seattle, WA (US); Parichay Saxena, Bellevue, WA (US); Patrice Y. Simard, Bellevue, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/147,963

(22) Filed: Jun. 27, 2008

(51) Int. Cl. G06F 3/00

(52) U.S. Cl. 715/730

(57) ABSTRACT

A presentation system is provided. The presentation system includes a presentation component that provides an electronic data sequence for one or more members of an audience. A monitor component analyzes one or more media streams associated with the electronic data sequence, where a processing component automatically generates a media stream index or a media stream augmentation for the electronic data sequence.

### BACKGROUND

Modern presentations at corporate meetings or seminars are often supplemented by high technology software. Presentations are typically given in slide format where various slides are presented via projection in front of a group of people. The presenter at such meetings often operates a mouse or other electronic device to move from one slide to the next as the presentation progresses. When presentations such as Power Point are given, context for the meeting is often lost such as questions asked by the audience or comments made between participants. Other feedback such as facial expressions, audio queues, or other audience dynamics that may be useful to the presenter are often lost while the given presentation is under way and the presenter is more focused on the next slide or idea to be conveyed.

To understand current software tools for presentations, a brief review of some of the salient features of such tools is provided. Modern presentation tools enable users to communicate ideas through visual aids that appear professionally designed yet are easy to produce. The tools generally operate over a variety of media, including black and white overheads, color overheads, 35 mm slides, web pages, and on-screen electronic slide shows, for example. All these components can be integrated into a single file composing a given presentation. Whether the presentation is in the form of an electronic slide show, 35 mm slides, overheads or paper print-outs, the process of creating the presentation is basically the same. For example, users can start with a template, a blank presentation, or a design template and build their respective presentations from there. To create these basic forms, there are several options provided for creating the presentation.

In one option, a series of dialog boxes can be provided that enable users to get started by creating a new presentation using a template. This can include answering questions about a presentation to end up with the ready-made slides. In another option, a blank presentation template is a design template that uses default formatting and design. These are useful if one desires to decide on another design template after working on the presentation content or when creating custom formatting and designing a presentation from scratch. In a third option, design templates enable new users to come up to speed with the tool in a rapid manner by providing presentation templates that are already formatted to a particular style. For example, if a user wanted to make a slide with bulleted points, a design template could be selected having bullet point markers where the user could merely enter the slide points they desired to make near the markers provided. Thus, the design template is a presentation that does not contain any slides but includes formatting and design outlines. It is useful for providing presentations with a professional and consistent appearance. Thus, users can start to create a presentation by selecting a design template or they can apply a design template to an existing presentation without changing its contents.

In still another option, a presentation template is a presentation that contains slides with a suggested outline, as well as formatting and design. It is useful if one needs assistance with content and organization for certain categories of presentations such as: Training; Selling a Product, Service, or an Idea; Communicating Bad News, and so forth. When creating a new presentation using a template, users are provided a set of ready-made slides where they then replace what is on the slides with the user's own ideas while inserting additional slides as necessary. This process of making presentations while useful is essentially static in nature. Once the presentation is selected and presented, the slides generally do not change all that much unless the author of the presentation manually updates one or more slides over time. Unfortunately, auxiliary information that is generated at any given meeting during a presentation is usually lost after the presentation is given.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Presentation and monitoring components are provided to automatically supplement an electronic presentation with audience feedback or other contextual queues that are detected during the course of the presentation. This can include capturing multiple media streams of video or audio that can be automatically recorded and attached to presentations during various points of the respective presentation. This allows users to go back and relive a presentation and hear the responses from the group of people attending a meeting in addition to the original presenter. Each time a presentation is made, data collections associated with the presentation can be archived to allow the presentation to be modified over time. Also, user comments in the room can be collected and later analyzed to see what others are thinking during various points in the presentation. Observing what was said during presentations can be supplemented with other context captured from meetings that enable supplementing and improving presentations over time. Audio frame based searching of the presentation can be provided along with authoring analysis of a given video or audio frame while storing a multitude of video clips, for example. Collapsing time and space, commenting on the presentation, asking questions, going back and searching, recording and finding questions asked by someone in audience can also be provided to automatically facilitate improvements in the presentation over time.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a presentation system that dynamically captures and augments data in accordance with an electronic presentation.

FIG. 2 is a block diagram that illustrates multiple media streams that are employed to update an electronic presentation.

FIG. 3 illustrates an automated system for automatically updating presentations.

FIG. 4 illustrates a system and context component for analyzing collected meeting data.

FIG. 5 illustrates an exemplary system for inferring context from a data stream and augmenting a presentation or index.

FIG. 6 illustrates a system illustrates auto tagging of data presentations from contextual data.

FIG. 7 illustrates data synchronization between models and applications.

FIG. 8 illustrates a general process for automatically generating augmentation data for a presentation.

FIG. 9 is a schematic block diagram illustrating a suitable operating environment.

FIG. 10 is a schematic block diagram of a sample-computing environment.

### DETAILED DESCRIPTION

Systems and methods are provided for automatically capturing contextual data during electronic media presentations. In one aspect, a presentation system is provided. The presentation system includes a presentation component (e.g., Power Point) that provides an electronic data sequence for one or more members of an audience. A monitor component analyzes one or more media streams associated with the electronic data sequence, where a processing component automatically generates a media stream index or a media stream augmentation for the electronic data sequence.

As used in this application, the terms “component,” “application,” “monitor,” “presentation,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

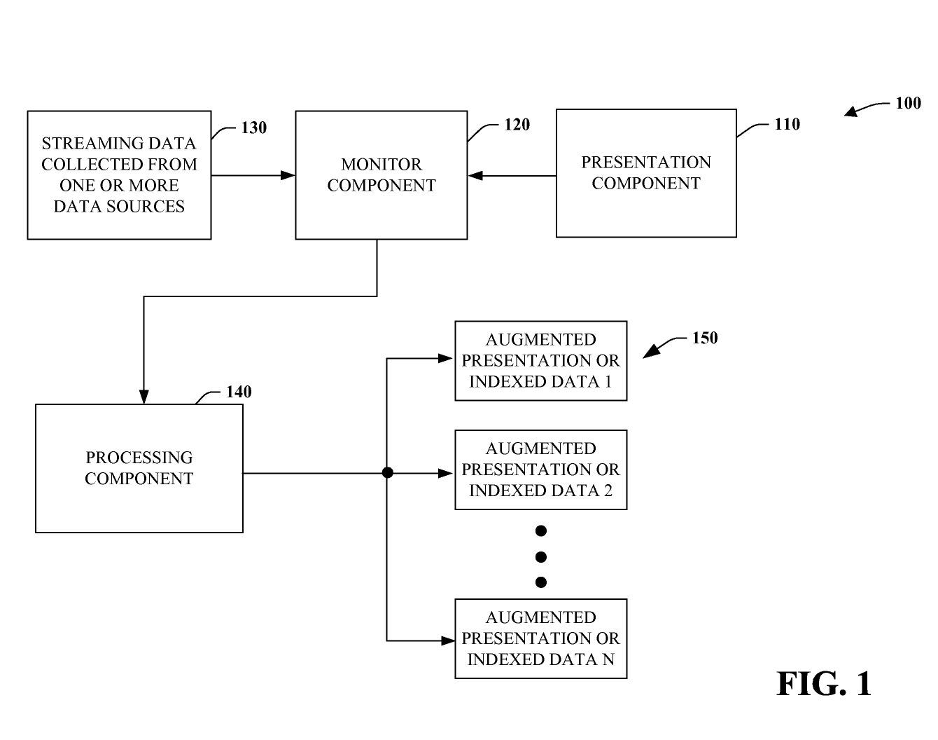

Referring initially to FIG. 1, a presentation system 100 that dynamically captures and augments data in accordance with an electronic presentation. A presentation component 110 such as Power Point for example, generates an electronic data sequence for one or more members of an audience. During the presentation which can include multiple forms of output including video presentations, data presentations, and/or audio presentations, a monitor component 120 monitors or captures user actions or gestures via one or more data source streams 130. The actions monitored at 120 include substantially any type of audience activity that may indicate a context for presentations. This can include monitoring voice communications, keyboard actions, facial monitoring, capturing meeting notes from meeting boards or laptops, program comments, design review comments, inter-party comments, questions, and so forth.

From these actions, relevant context can be determined, where a processing component 140 communicates with the monitor component 120 and automatically generates an augmented presentation or an index at 150 that captures the context. For instance, in one aspect an electronic index can be automatically constructed at 150 by the processing component 140. In this case the index can include all activity for a given presentation in general or be indexed on a more granular nature such as cataloging all commentary or questions associated with a particular slide or other data presentation. In another aspect, the processing component can employ higher level learning or mining processes to automatically associate the captured data streams 130 with the data sequences generated by the presentations component 110. It is noted that as used herein, a data sequence can include slides that are presented over the course of time or real-time data such as video or audio data that can be interspersed with or used in place of static slide sequences.

In general, the presentation, monitoring components, and processing components (110, 120, and 140 respectively) are provided to automatically supplement an electronic presentation with audience feedback or other contextual queues that are detected during the course of the presentation. This can include capturing multiple media streams 130 of video or audio that can be automatically recorded and attached to presentations at 150 during various points of the respective presentation. Such data can also be captured separately if desired in the form of an index as previously described. This allows users to go back and relive a presentation and hear the responses from the group of people attending a meeting in addition to the original presenter. Each time a presentation is made, data collections associated with the presentation can be archived to allow the presentation to be modified over time. Also, user comments or other expressions (e.g., facial expressions) in the room can be collected and later analyzed to see what others are thinking during various points in the presentation. Observing what was said during presentations can be supplemented with other context captured from meetings that enable supplementing and improving presentations over time. Audio frame based searching of the presentation can be provided along with authoring analysis of a given video or audio frame while storing a multitude of video/audio clips, for example. Collapsing time and space, commenting on the presentation, asking questions, going back and searching, recording and finding questions asked by someone in audience can also be provided to automatically facilitate improvements in the presentation over time.

Recorded meetings include auto-tagging media streams 130 such as this meeting or portion was boring, using tagging to add context to what was recorded, finding the time some event occurred, tagging video and audio separately, utilizing a portion of a stream tagged as highlights, where one person may highlight recording and that data is used later, and noting that the majority of the audience are paying attention. Additional context can be added to recordings and employed as tags. State and authorization data can be persisted, where persisting state of connection in terms of on and off having one push per application or per device if desired.

In another aspect, a component can be provided for federated identification and state capture, to have authorized connections, where that authorization is persisted across data structures and presentations. This maintains state connection and authorization information, persisting state across connections, to only have to login once, provide one password, and persist it across application and security domains. Persisted states on multiple devices can be provided such as where did a user leave off in a presentations, what happened since the user left off—similar to persisting state across devices as opposed to applications. The state can be updated since last used or last connected and can be employed to update the index or presentation at 150.

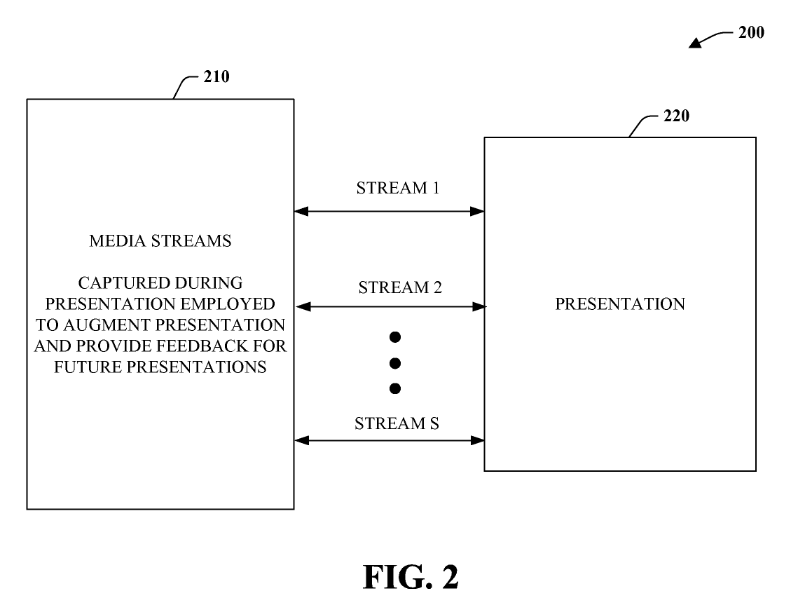

Referring now to FIG. 2, a system 200 illustrates multiple media streams 210 that are employed to update an electronic presentation 220. The media streams 210 can be captured from substantially any source before, during, or after a meeting where a given electronic presentation 220 is given. These can include captured audio files for example where participants discuss meeting aspects, comments between participants, e-mails between participants, questions directed at the presenter of the meeting and so forth. Video captures can include recording the participants as they view a meeting or more focused forms can be captured such as analyzing particular meeting members for facial expressions or other biometric feedback described below. For example, profiles (described below) can be configured to cause a camera or other meeting capture device to focus in on a particular audience member or members. Perhaps a meeting is given to high level management and it is important to determine reactions from key high-level managers while the presentations are given.

As can be appreciated, data can be collected from audio sources, computer sources, cell phones or other wireless devices, video input sources and so forth. In one aspect, future meeting rooms can be adapted with sensory equipment to gauge individual audience reactions and collect data in general from the group. The presentation 220 can be provided from a plurality of sources. These can include slide presentations (e.g., Power Point), video presentations, audio presentations, or a combination of data presentation mediums. Substantially any type of electronic presentation software can be employed, where the software is augmented via captured context data from a respective meeting or meetings. After meetings have commenced, often times e-mails or other electronic exchanges occur that can be captured and employed to augment a given meeting or indexed for historical documentation regarding a particular meeting subject.

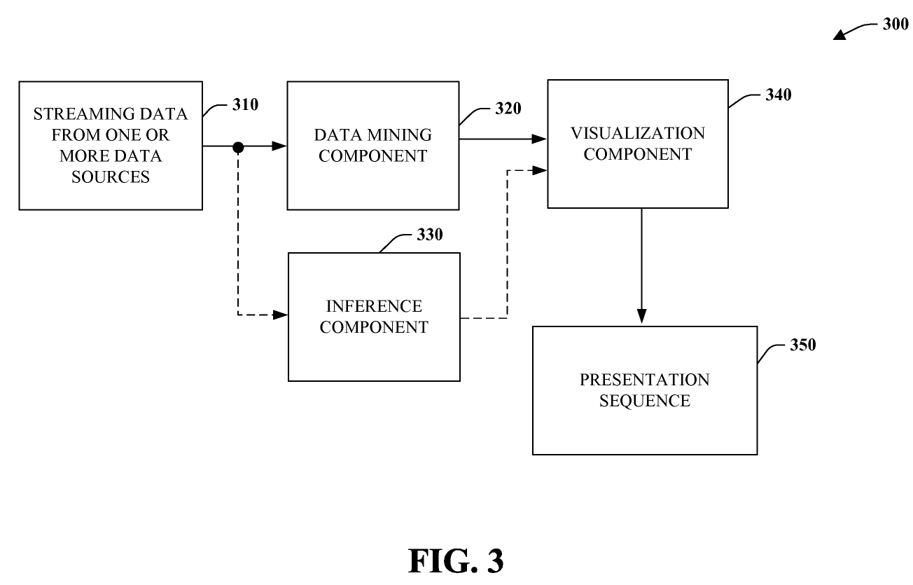

Turning to FIG. 3, an automated system 300 is illustrated for automatically updating presentations. In this aspect, one or more data streams 310 are collected or aggregated. The data streams 310 can be processed by a data mining component 320 and/or an inference component 330 to determine contextual data from the data streams. Such data can be employed to determine other more suitable presentations or augmentations that can be utilized to enhance a presentation or sequence by augmenting the presentation with the determined contextual data. As illustrated, after contextual information is determined from the data streams 310, a visualization component 340 dynamically generates a presentation sequence at 350 that utilizes the data determined by the data mining component 320 or the inference component 330.

The system 300 operates in a predictive or inference based mode and can be employed to supplement the monitoring and presentations depicted in FIG. 1. Thus, even though a present data set may be partial or incomplete, the system 300 does not have to wait for all data to be collected but can generate refined data based off of predictions for missing members in the data set. Augmentations or other data collections can also include observing trends in the data and predicting where subsequent data may lead. Controls can be provided to enable users to enter queries or define policies that instruct the data mining component 320 or the inference component 330 for the types of information that may be of interest to be collected for a particular user. This includes anticipating a presentation 350 based off a function of data 310 received to that point. The system 300 can be employed as a contextual generator system for creating presentations and dynamically refining the presentations or associated electronic sequences over time.

In yet another aspect, real-time, streaming data 310 is analyzed according to trends or other type of analysis detected in the data that may indicate or predict what information will be useful in the future based off of presently received data values. This includes making predictions regarding potential questions that may be asked for a given electronic sequence. Data mining 320 and/or inference components 330 (e.g., inference derived from learning components) are applied to data that has been received at a particular point in time. Based off of mining or learning on the received data, contextual data or predictive data is generated and subsequently visualized at 350 according to one or more dynamically determined display options for the respective data that is collected or aggregated. Such visualizations or presentations can provide useful insights to those viewing the data, where predictive information is visualized to indicate how data or outcomes might change based on evidence gathered at a particular point in time such as during a meeting for example. Feedback options (not shown) can be provided to enable users to guide presentations or further query the system 300 for other types of analysis based in part on the respective query supplied to the system.

In another aspect, an electronic presentation system is provided. The system includes means for monitoring (e.g., monitor component 120 of FIG. 1) multiple data streams 310 that are generated during an electronic meeting presentation 350. The system also includes means for determining a data context from the data streams (e.g., data mining component 320 or inference component 330) and means for automatically updating the electronic media presentation (e.g., processing component 140 of FIG. 1) in view of the data context.

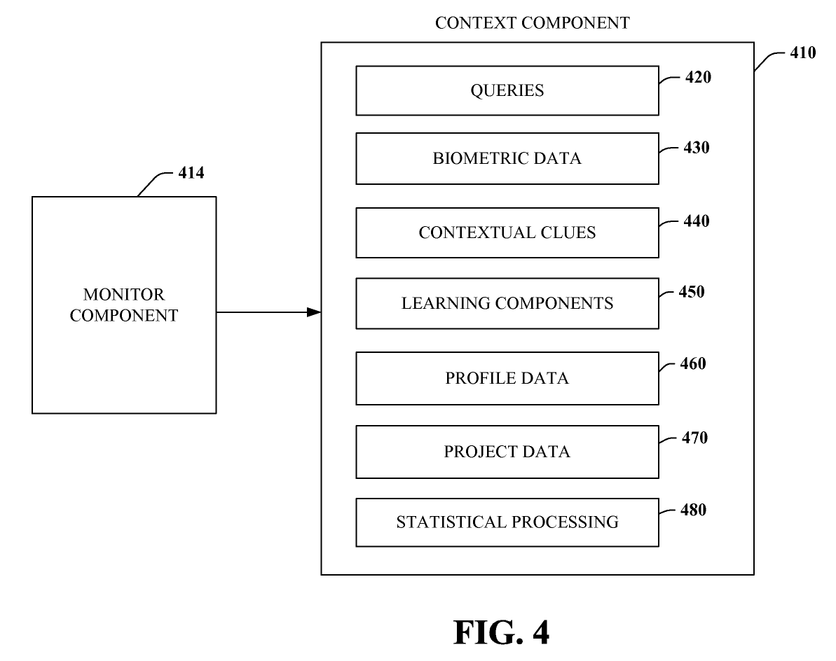

Referring now to FIG. 4, a system 400 and context component 410 for analyzing collected meeting data is illustrated. The context component 410 analyzes collected data such as have been previously detected by a monitor component 214 described above. The context component 410 shows example factors that may be employed to analyze data to produce augmented data for presentations or for indexed data as described above. It is to be appreciated that substantially any component that analyzes streaming data at 414 to automatically generate augmentation or indexed data can be employed.

Proceeding to 420, one aspect for capturing user actions includes monitoring queries that a respective user may make such as questions generated in a meeting or from laptop queries or other electronic media (e.g., e-mails generated from a meeting). This may include local database searches for information in relation to a given topic or slide where such query data (e.g., key words employed for search) can be employed to potentially add context to a given meeting or presentation. For example, if a search were being conducted for the related links to a meeting topic, the recovered links may be used to further document a current topic. Remote queries 420 can be processed such as from the Internet where data learned or derived from a respective query can be used to add context to a presentation.

At 430, biometric data may be analyzed. This can include analyzing keystrokes, audio inputs, facial patterns, biological inputs, and so forth that may provide clues as to how important a given piece of presentation data is to another and based how an audience member processes the data (e.g., spending more time analyzing a slide may indicate more importance). For example, if a user were presenting a sales document for automobiles and three different competitors were concurrently analyzed, data relating to the competitors analyzed can be automatically captured by the context component 410 and saved to indicate the analysis. Such contextual data can be recovered and added to a presentation that later employs the document where it may be useful to know how such data was derived.

At 440, one or more contextual clues may be analyzed. Contextual clues can be any type of data that is captured that further indicates some nuance to a meeting that is captured outside the presentation itself. For example, one type of contextual data would be to automatically document the original meeting notes employed and perhaps providing links or addresses to the slides associated with the notes. This may also include noting that one of the collected media streams was merely used as a background link whereas another stream was employed because the content of the stream was highly relevant to the current meeting or discussion.

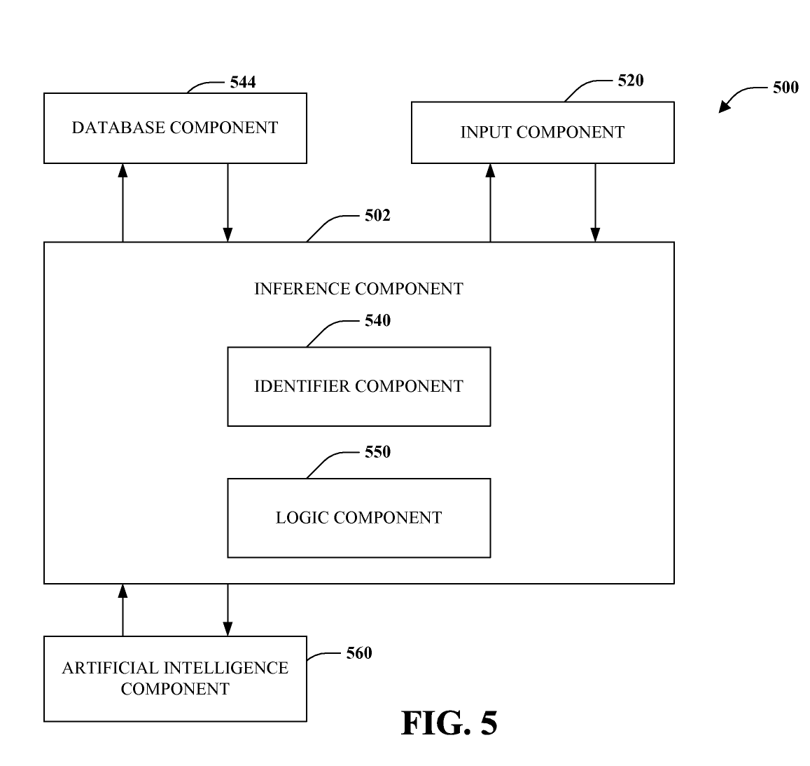

At 450, one or more learning components can be employed by the context component 410. This can include substantially any type of learning process that monitors activities over time to determine how to annotate, document, or tag data in the future and associate such data with a given presentation or index. For example, a user could be monitored for such aspects as where in a presentation they analyze first, where their eyes tend to gaze, how much time they spend reading near key words and so forth, where the learning components 450 are trained over time to capture contextual nuances of the user or group. The learning components 450 can also be fed with predetermined data such as controls that weight such aspects as key words or word clues that may influence the context component 410. Learning components 450 can include substantially any type of artificial intelligence component including neural networks, Bayesian components, Hidden Markov Models, Classifiers such as Support Vector Machines and so forth and are described in more detail with respect to FIG. 5.

At 460, profile data can influence how context data is collected. For example, controls can be specified in a user profile that guides the context component 210 in its decision regarding what should and should not be included as augmentation data with respect to a given slide or other electronic sequence. In a specific example, a systems designer specified by profile data 460 may be responsible for designing data structures that outline code in a more high level form such as in pseudo code. Any references to specific data structure indicated by the pseudo code may be noted but not specifically tagged to the higher level code assertions. Another type of user may indicate they are an applications designer and thus have preferences to capture more contextual details for the underlying structures. Still yet other type of profile data can indicate that minimal contextual data is to be captured in one context where maximal data is to be captured in another context. Such captured data can later be tagged to applications and presentations to indicate to other users what the relevant contexts were when the presentation was given.

At 470, substantially any type of project data can be captured and potentially used to add context to a presentation or index. This may include design notes, files, schematics, drawings, comments, e-mails, presentation slides, or other communication. This could also include audio or video data from a meeting for example where such data could be linked externally from the meeting. For example, when a particular data structure is tagged as having meeting data associated with it, a subsequent user could select the link and pull up a meeting that was conducted previously to discuss the given portion of a presentation. As can be appreciated, substantially any type of data can be referenced from a given tag or tags if more than one type of data is linked.

At 480, substantially any type of statistical process can be employed to generate or determine contextual data. This can include monitoring certain types of words such as key words for example for their frequency in a meeting, for word nearness or distance to other words in a paragraph (or other media), or substantially any type of statistical processes that is employed to indicate additional context for a processed application or data structure. As can be appreciated, substantially any type of data that is processed by a user or group can be aggregated at 410 and subsequently employed to add context a presentation.

Referring to FIG. 5, an exemplary system 500 is provided for inferring context from a data stream and augmenting a presentation or index. An inference component 502 receives a set of parameters from an input component 520. The parameters may be derived or decomposed from a specification provided by the user and parameters can be inferred, suggested, or determined based on logic or artificial intelligence. An identifier component 540 identifies suitable steps, or methodologies to accomplish the determination of a particular data item (e.g., observing a data pattern and determining a suitable presentation or augmentation). It should be appreciated that this may be performed by accessing a database component 544, which stores one or more component and methodology models. The inference component 502 can also employ a logic component 550 to determine which data component or model to use when analyzing real time data streams and determining a suitable presentation or augmentation to an electronic sequence there from. As noted previously, classifiers or other learning components can be trained from past observations where such training can be applied to an incoming data stream. From current received data streams, future predictions regarding the nature, shape, or pattern in the data stream can be predicted. Such predictions can be used to augment one or more dynamically generated augmentations or indexes as previously described.

When the identifier component 540 has identified the components or methodologies and defined models for the respective components or steps, the inference component 502 constructs, executes, and modifies a visualization based upon an analysis or monitoring of a given application. In accordance with this aspect, an artificial intelligence component (AI) 560 automatically generates contextual data by monitoring real time data as it is received. The AI component 560 can include an inference component (not shown) that further enhances automated aspects of the AI components utilizing, in part, inference based schemes to facilitate inferring data from which to augment a presentation. The AI-based aspects can be affected via any suitable machine learning based technique or statistical-based techniques or probabilistic-based techniques or fuzzy logic techniques. Specifically, the AI component 560 can implement learning models based upon AI processes (e.g., confidence, inference). For example, a model can be generated via an automatic classifier system.

It is noted that interface (not shown) can be provided to facilitate capturing data and tailoring presentations based off the captured information. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI can include a display having one or more display objects (not shown) for manipulating electronic sequences including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI.

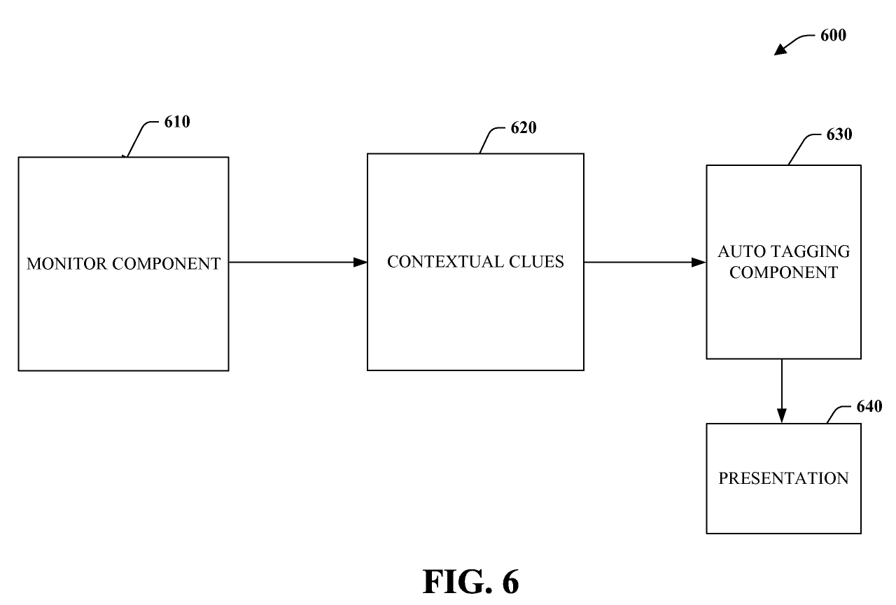

Referring now to FIG. 6, a system 600 illustrates auto tagging of data presentations from contextual data. In many cases, the monitored data previously described can be employed to add further context to existing works, other models, schemas, and so forth. Thus, a monitor component 610 that has captured some type of data context can transmit data in the form of contextual clues 620 to an auto tagging component 630 which annotates the clues within a given presentation 640 for example. Thus, if some data were captured by the monitor component 610 relating to a given application or presentation, such data could be transported in the form of one or more contextual clues 620. Although not shown, such data could be transformed to a different type of data structure before being transmitted to the auto tagging component 630. Upon receipt of such data, the auto tagging component 630 appends, annotates, updates, or otherwise modifies a presentation or index 640 to reflect the contextual clues 620 captured by the respective monitor component 610.

In one example, the monitor component 610 may learn (from learning component) that the user has just received instructions for upgrading a presentation algorithm with a latest software revision. As the revision is being implemented, a contextual clue 620 relating to the revision could be transmitted to the auto tagging component 630, where the presentation 640 is then automatically updated with a comment to note the revision. If a subsequent user were to employ the presentation 640, there would be little doubt at which revisions were employed to generate the presentation. As can be appreciated, contextual clues 620 can be captured for other activities than noting a revision in a document. These can include design considerations, interface nuances, functionality considerations, and so forth.

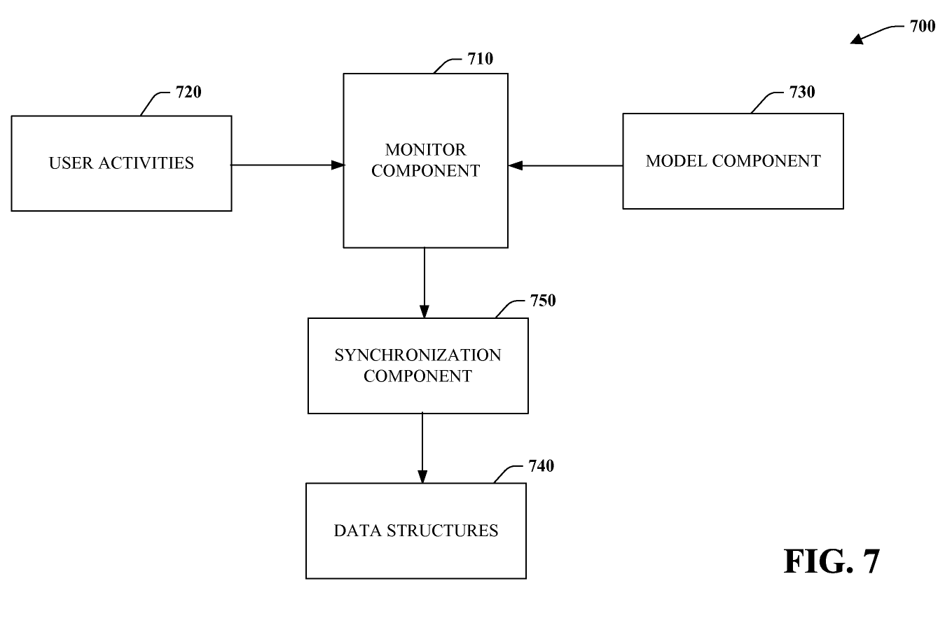

Referring to FIG. 7, a system 700 illustrates data synchronization between models and applications. A monitor component 710 analyzes observes user activities 720 over time (e.g., analyze audience members during electronic presentations). In accordance with such monitoring, one or more model components 730 that have been trained or configured previously are also processed by the monitor component 710. In some cases, a change in the user activities 720 may be detected where the model component 730 is updated and/or automatically adjusted. In such cases, it may be desirable to update or synchronize other data structures 740 that have previously been modified by the model component 730. As shown, a synchronization component 750 can be provided to automatically propagate a detected change to the data structures 740, where the data structures can be employed to augment a presentation or index data in relation to the presentation. Although not shown, rather than allowing automatic updates to occur in the data structures 740, the synchronization component 750 could invoke a user interface to inquire whether or not the user desires such synchronization.

Other aspects can include storing entire user history for the model components 730, analyzing past actions over time, storing the patterns, detecting a link between data structures 740 and querying users if they want to maintain synchronization link or not between the data structures. Other monitoring for developing model components 730 include monitoring for biometrics such as monitoring how users are inputting data to further develop the models, analyzing the patterns and relating to a user's profile. If such data were to be considered relevant to the data structures via processing determinations, then further synchronization between structures could be performed.

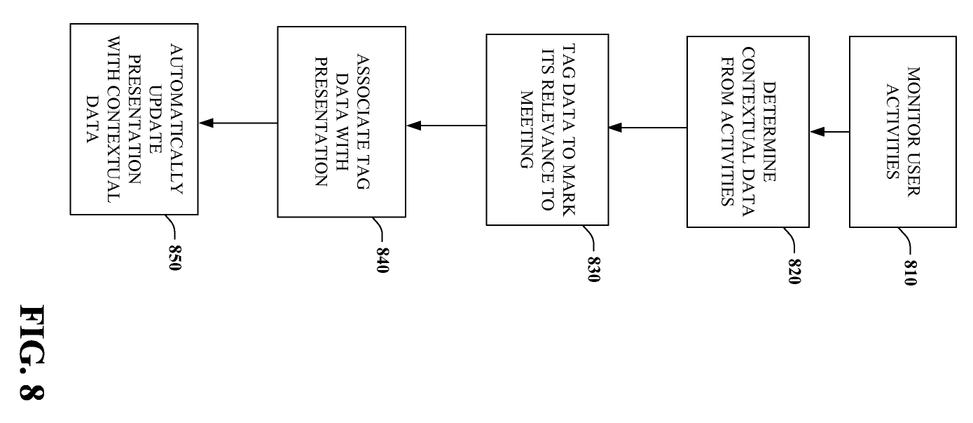

FIG. 8 illustrates exemplary process for automatically generating augmentation data for a presentation. While, for purposes of simplicity of explanation, the process is shown and described as a series or number of acts, it is to be understood and appreciated that the subject process is not limited by the order of acts, as some acts may, in accordance with the subject process, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

FIG. 8 illustrates a general process for monitoring meeting data and automatically updating electronic presentations over time. Proceeding to 810, user activities are monitored over time. This can include monitoring computer processes such as keyboard inputs, audio or video inputs, phone conversations, meetings, e-mails, instant messages, or other biofeedback devices to capture user intentions and context while a given meeting is underway. This can also include collecting follow on data such as e-mail activity that has been generated in view of the respective meeting. At 820, contextual data is determined from the monitored activities. This can include simpler processes such as capturing all sounds or video associated with a particular slide or more sophisticated processes such as data mining or inference to actually determine if some portion of data is contextually relevant to a given discussion or meeting.

Proceeding to 830, data is tagged to mark its relevance to a given meeting or presentation. For example, if a question were asked by an audience member during slide seven, an example tag for the captured question might be “Question Slide 7.” Such tags can be indexed in a historical database or employed to actually mark a particular slide or presentation medium with the fact that a piece of extraneous data to the presentation has been generated. At 840, the tags generated at 840 are associated with a given slide or media portion of a presentation. This can include isolating points in time when a particular piece of data was collected and adding metadata to a slide (or other electronic data) to indicate that a tag was generated. In addition to determining time synchronization points, other markers can include noting that a particular slide is presented and marking substantially all data collected for that slide as belonging to that particular slide. Of course meeting data can be generated that is out of sync with a given slide, thus more sophisticated processing components can be employed to determine that the context is with another slide or topic where the collected data is marked as such.

At 850, after data has been captured, presentations can be automatically augmented with the captured data. This can include associating the captured data as metadata to a particular file or slide or more sophisticated analysis processes where the slide itself is updated. In a simple example, an audience member may point out a flaw in a particular point in a presentation. Analysis tools can determine the context for the comment and automatically update a slide or other presentation in view of such commentary.

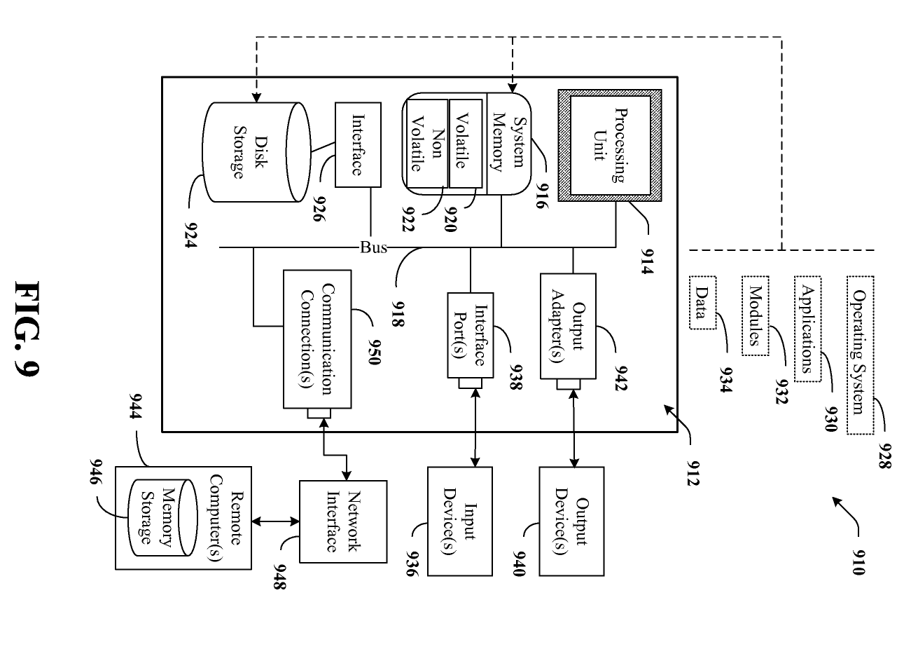

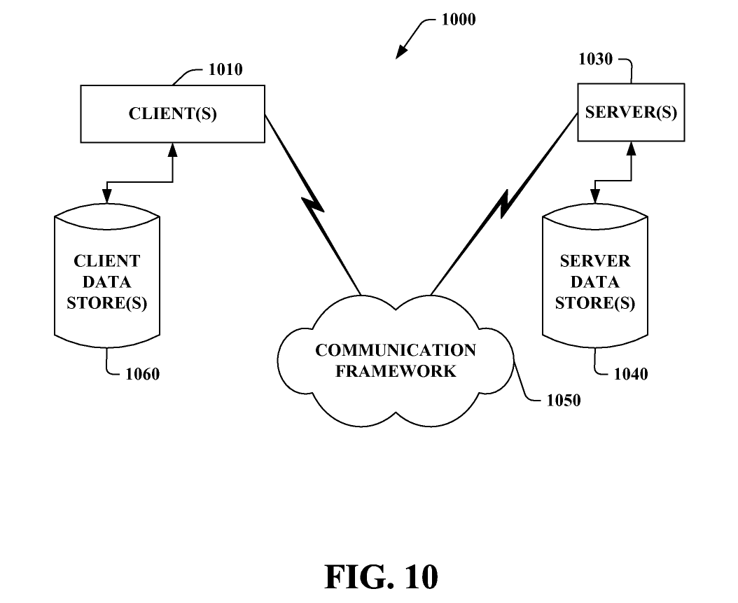

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing device (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 9, an exemplary environment 910 for implementing various aspects described herein includes a computer 912. The computer 912 includes a processing unit 914, a system memory 916, and a system bus 918. The system bus 918 couple system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, multi-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912 and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A presentation system, comprising:
a presentation component that provides an electronic data sequence for one or more members of an audience;
a monitor component to analyze one or more media streams associated with the electronic data sequence; and
a processing component to automatically generate a media stream augmentation for the electronic data sequence.

2. The system of claim 1, the processing component automatically generates a media stream index for the electronic data sequence.

3. The system of claim 1, further comprising a contextual data component to enable capture of context data and configuration of the types of data to capture.

4. The system of claim 3, the contextual data component captures audio streams, video streams, e-mails, queries, biometric data, contextual clues, and project related data.

5. The system of claim 4, the contextual data component includes learning components, profile components, and statistical processing components to process contextual data.

6. The system of claim 1, further comprising an auto-tagging component to indicate an association between a presentation and a captured data stream.

7. The system of claim 1, further comprising a synchronization component to associate captured data with different portions of a presentation.

8. The system of claim 1, further comprising a data mining component to determine a data context for a captured data stream.

9. The system of claim 1, further comprising a learning component to determine a data context for a captured data stream.

10. The system of claim 1, further comprising a component to add context to a recording.

11. The system of claim 1, further comprising a component determine when a time when a meeting event occurred.

12. The system of claim 1, further comprising a component that enables tagging video and audio as separate components.

13. The system of claim 1, further comprising a component to tag a portion of a media stream as highlights, where a user may highlight a recording, where the portion is used later noting that some part of an audience is attentive.

14. The system of claim 1, further comprising a component to persist state and authorization data across meetings and data capture events.

15. The system of claim 1, the presentation component is associated with an electronic slide presentation.

16. A method to automatically augment electronic presentations, comprising:
monitoring multiple data streams that are generated during an electronic meeting presentation;
determining a data context from the data streams;
applying tags to the data context to indicate a relationship to the meeting presentation;
associating the tags with the electronic media presentation; and
automatically updating electronic media presentation in view of the tags and the data context.

17. The method of claim 16, further comprising synchronizing data structures when monitoring user activities.

18. The method of claim 16, further comprising tagging data structures to indicate a relevance to a selected portion of the electronic media presentation.

19. The method of claim 16, further comprising inferring meeting context data from a captured media stream.

20. An electronic presentation system, comprising:
means for monitoring multiple data streams that are generated during an electronic meeting presentation;
means for determining a data context from the data streams; and
means for automatically updating the electronic media presentation in view of the data context.
